(19) United States
(12) Patent Application Publication
(10) Pub. No.: US 2018/0034811 A1
(43) Pub. Date: Feb. 1, 2018

(54) Method and System for Authenticating a User with Service Providers Using a Universal One Time Password

(71) Applicant: Taiwan Depository & Clearing Corporation, Taipei City (TW)

(72) Inventor: Ching-Li Meng, Taipei City (TW)

(21) Appl. No.: 15/658,400

(22) Filed: Jul. 25, 2017

(30) Foreign Application Priority Data
Jul. 29, 2016 (TW) 105124257

(51) Int. Cl. H04L 29/06

(52) U.S. Cl. CPC H04L 63/0838; G06Q 40/04

(57) ABSTRACT

A method for authenticating a user with service providers using a Universal OTP is provided, wherein a first request is received by a server from a first account on a mobile device of a user, wherein the first account is registered with said server; the first account is associated with a plurality of second accounts of service providers; the server transmits a Universal OTP to the mobile device, wherein the Universal OTP is not bound to any particular one of the plurality of second accounts; a terminal device of a first service provider inputs said Universal OTP and sends a second request to the server, wherein the second request comprises the Universal OTP and identification of the first service provider; and the server determines a corresponding second account of the first service provider according to the Universal OTP and identification of the first service provider so as to transmit information of the corresponding second account to the terminal device for authenticating the user.

### CROSS-REFERENCES TO RELATED APPLICATIONS

This patent application claims priority of Taiwan Patent Application No. 105124257, filed on Jul. 29, 2016, the entirety of which is incorporated herein by reference.

### BACKGROUND OF THE INVENTION

### I. Field of the Invention

The present invention relates to a method for authenticating a user with a service provider, and more particularly to a method for authenticating a user with a service provider using a one-time password (ONE TIME PASSWORD, OTP).

### II. Description of the Prior Art

In general, when a customer wants to open an account with any financial institution, it is necessary to provide proof of identity and contact information, such as name, identity card number, contact address and other personal information. When the account opening process is completed, the customer will usually have an account number. The customer may choose to access the services provided by the financial institution through web pages, ATMs, or teller counters. When the customer conduct transactions at the counter, a paper passbook is presented. The paper passbook serves two functions. The first function is to provide a method for the user to be identified and validated at the financial institution. The second function is to provide a method for the user to record and verify account information. When accessing financial services provided any financial institutions, the user must first present the paper passbook to verify his identity. However, managing the plurality of paper passbooks can cause a burden to the user when the user has multiple accounts with multiple financial institutions.

When a user has multiple accounts with multiple financial institutions, the user must keep multiple paper passbooks. For example, the paper passbook A corresponds to the financial institution A, the paper passbook B corresponds to the financial institution B, the paper passbook C corresponds to the financial institution C and so on. Though the multiple paper passbooks are not identical, the size of the paper passbook is usually the same, making it difficult to distinguish at first glance. The user often goes to financial institutions with a wrong passbook, such as taking along the real passbook A to the financial institution B, or taking along the real passbook A to the financial institution C. The user may temporarily need financial services, however, because of without taking along the real passbook in advance, there will be to additionally arrange the predicament of time, which is very inconvenient.

Many users can access financial services through mobile devices thanks to the popularity of the Internet. Nowadays, numerous financial institutions also provide the users with web pages or mobile applications that enable users to access the financial services they provide through mobile devices.

However, while mobile devices enable users to access financial services from multiple financial institutions in a situation where users have multiple accounts with multiple financial institutions, user identity authentication will be difficult. It is highly likely that the mobile device must have multiple mobile applications installed like the paper passbook. At present, PKI technology or one-time password are used to authenticate user identity. However, the traditional PKI authentication technology or one-time password is limited to one user and one single service provider for authenticating the user identity. If the service providers, such as multiple brokerage firms, use different systems to authenticate a user identity, too many complicated authentication procedures will be imposed on the user, and the user must remember too many passwords for the authentication procedures, which will cause inconvenience for the user.

Accordingly, how to effectively use a one-time password to authenticate a user identity with multiple service providers, such as multiple brokerage firms or banks, is an important topic in the industry.

### SUMMARY OF THE INVENTION

One object of the present invention is to provide a method and system for authenticating a user identity with multiple service providers using a Universal OTP.

In one embodiment, at least one server is connected to multiple terminal devices of multiple brokerage firms. Each user may establish an account at any of the brokerage firms. The at least one server can obtain all brokerage account information of the user by a mobile device application to enable the user to communicate with the at least one server to check the status of all of the electronic passbooks. The mobile APP provides an integrated interface that links to all of the user's brokerage accounts so that the users can browse all of his brokerage accounts by using the mobile APP. When a user has multiple brokerage accounts, the mobile APP may provide an integrated interface for the user to acquire a Universal OTP. When a terminal device of a particular brokerage firm scans or inputs the Universal OTP acquired by the user, the terminal device sends a request to the at least one server, wherein the request includes the identification code of the brokerage firm. The at least one server then verifies that the user indeed owns a brokerage account of the brokerage firm based on the identification code of the brokerage firm in the request and the Universal OTP, and then transmits the brokerage account information of the user to the terminal device of the brokerage firm so as to complete the authentication procedure. That is, when a user acquires the Universal OTP, the Universal OTP is not bound to any brokerage firm. Until a brokerage firm scans or inputs the Universal OTP, which will bound the Universal OTP to this brokerage firm, and therefore it will allow the user to have a number of different brokerage accounts while using an integrated interface for acquiring the Universal OTP. Please note that the user interface to acquire the Universal OTP can list some or all of the brokerage accounts of the user for the user to choose.

In one embodiment, at least one server is connected to terminal devices of multiple banks. Each user may establish an account at any of the banks. The at least one server can obtain all bank account information of the user by using a mobile APP to communicate with the at least one server to check the status of all of the electronic passbooks. The mobile APP provides an integrated interface that links to all of the user's bank accounts so that the users can browse all of his bank accounts by using the mobile APP. When a user has multiple bank accounts, the mobile APP can provide an integrated interface for the user to acquire a Universal OTP. When a terminal device of a certain bank scans or inputs the Universal OTP acquired by the user, the terminal device sends a request to the at least one server, wherein the request includes the identification code of the bank. The at least one server then verifies that the user indeed owns the bank account based on the identification code of the bank in the request and the Universal OTP, and then transmits the bank account information of the user to the terminal device of the bank to complete the authentication procedure. That is, when a user acquires the Universal OTP, the Universal OTP is not bound to any bank until a bank scans or inputs the Universal OTP, which bounds the Universal OTP to this brokerage firm, and therefore it will allow the user to have a number of different bank accounts while using an integrated interface for acquiring the Universal OTP. Please note that the user interface to acquire the Universal OTP can list some or all of the bank accounts of the user for the user to choose.

In one embodiment, the present invention discloses a method of for authenticating a user identity with a plurality of service providers using a Universal OTP, said method comprising: receiving a first request from a first account on a mobile device of a user using at least one server, wherein the first account is associated with said at least one server, wherein the first account is associated with a plurality of second accounts corresponding to a plurality of service providers, wherein information of the plurality of second accounts are associated with said at least one server; transmitting a Universal OTP to the mobile device of the user using said at least one server, wherein the Universal OTP is not bound to any particular one of the plurality of second accounts; receiving a second request from a terminal device of a first service provider using said at least one server, wherein the second request comprises said Universal OTP and identification information of the first service provider; and determining a corresponding account of the plurality of second accounts of the first service provider according to the Universal OTP and the identification information of the first service provider of the received second request using said at least one server so as to transmit information relevant to a corresponding account to the terminal device of the first service provider to complete the authentication.

In one embodiment, wherein the plurality of service providers comprises financial institutions.

In one embodiment, wherein the plurality of service providers comprises insurance companies.

In one embodiment, wherein the plurality of service providers comprises banks.

In one embodiment, the at least one server comprises at least one server of a depository and clearing house and the plurality of service providers are associated with the depository and clearing house.

In one embodiment, the terminal device is an intelligent workstation or an internal computer system of the first service provider.

In one embodiment, registration of the first account on the mobile device of the user comprises electronic registration or in-person registration, and wherein the electronic registration or in-person registration is accomplished by said at least one server.

In one embodiment, registration of the first account on the mobile device of the user comprises the following steps: receiving a registration request from the mobile device using the at least one server, said request comprising information about a second account of a first service provider; and establishing a first account using the at least one server as well as transmitting the first account and a registered passcode to the mobile device, wherein the first account is associated with the mobile phone number, the email account and a password of the user.

In one embodiment, the Universal OTP is a one-dimensional bar code or a two-dimensional bar code, wherein the Universal OTP is transmitted electronically or manually to the terminal device of the first service provider.

In one embodiment, the Universal OTP has a valid period.

In one embodiment, the first request is transmitted through a mobile device application, wherein a registered passcode is input into the mobile device to complete the registration of the first account prior to transmitting the first request.

In an embodiment, the present invention discloses a system for authenticating a user with a plurality of service providers using a Universal OTP, said system comprising: at least one server for receiving a first request from a first account on a mobile device of a user, wherein the first account is associated with said at least one server, the first account is associated with a plurality of second accounts corresponding to a plurality of service providers, and information of the plurality of second accounts are associated with said at least one server, wherein a Universal OTP is transmitted to the mobile device of the user according to the received first request, and the transmitted Universal OTP is not bound to any particular one of the plurality of second accounts; and a terminal device for inputting the Universal OTP in the mobile device and transmitting a second request to the at least one server, wherein the second request comprises said Universal OTP and identification information of the first service provider, wherein a corresponding account of the plurality of second accounts of the first service provider is determined according to the Universal OTP and identification information of the first service provider in the received second request, so as to transmit information relevant to a corresponding account to the terminal device of the first service provider to complete the authentication.

In one embodiment, the plurality of service providers comprise financial institutions.

In one embodiment, the plurality of service providers comprise insurance companies.

In one embodiment, the plurality of service providers comprise banks.

In one embodiment, the at least one server of the system comprises at least one server of a depository and clearing house and the plurality of service providers are associated with the depository and clearing house.

In one embodiment, registration of the first account on the mobile device of the user comprises electronic registration or in-person registration, and wherein the electronic registration or in-person registration is accomplished by said at least one server.

In one embodiment, the registration of the first account on the mobile device of the user is completed first, and the first account is then registered with the service provider in person.

In one embodiment, the second account on the mobile device of the user is registered first, and then completing the registration of the first account.

In one embodiment, registration of the first account on the mobile device of the user comprises the following steps: receiving a registration request from the mobile device using the at least one server, said request comprising information about a second account of a first service provider; and establishing a first account using the at least one server and transmitting the first account and a registered passcode to the mobile device, wherein the first account is associated with the mobile phone number, the email account and a password of the user.

In one embodiment, the Universal OTP is a one-dimensional bar code or a two-dimensional bar code, wherein the Universal OTP is transmitted electronically or manually to the terminal device of the first service provider.

In one embodiment, the Universal OTP has a valid period.

In one embodiment, the first request is transmitted through a mobile device application, wherein a registered passcode is input into the mobile device to complete the registration of the first account prior to transmitting the first request.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a schematic view illustrating a system using a Universal OTP for authentication.

FIG. 2 is a flow chart illustrating a method using a Universal OTP for authentication.

FIG. 3 a flow chart illustrating registration of the first account number for acquiring the Universal OTP;

FIG. 4 is a schematic view of the structure of a mobile phone passbook application architecture;

FIG. 5 is a schematic view of the hardware structure of the depository system of an unbiased third party system in FIG. 1; and

FIG. 6 is a schematic view of the software architecture of the aforementioned depository system.

### DETAILED DESCRIPTION OF THE INVENTION

The present invention is described in detail below. The preferred embodiments described are for illustrative and descriptive purposes and are not intended to limit the scope of the invention.

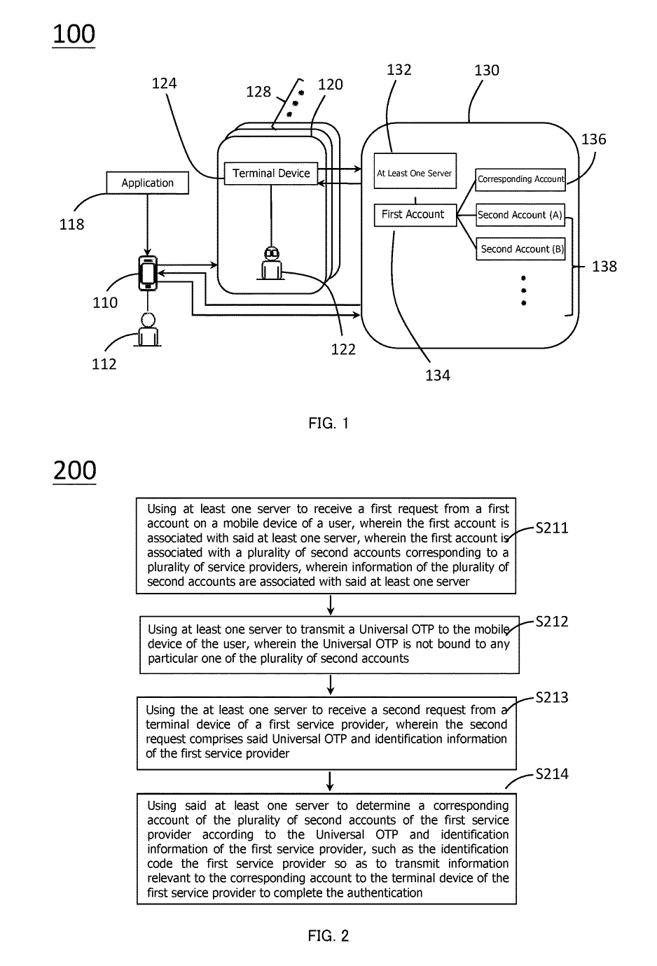

FIG. 1 is a schematic view illustrating a method of using a one-time password to authenticate a user with a plurality of service providers, comprising: at least one server 132 for receiving a first request from a first account 134 on a mobile device 110 of a user 112, wherein the first account 134 is associated with said at least one server 132, the first account 134 is associated with a plurality of second accounts 138 corresponding to a plurality of service providers 128, and information of the plurality of second accounts 138 are associated with said at least one server 132, wherein the at least one server 132 transmits a Universal OTP to the mobile device 110 of the user 112 with the Universal OTP not bound to any particular one of the plurality of second accounts 138; and a terminal device 124 for inputting the Universal OTP in the mobile device 110 and transmitting a second request to the at least one server 132, wherein the second request comprises said Universal OTP and identification information of the first service provider 120, wherein a corresponding account 136 of the plurality of second accounts of the first service provider is determined according to the Universal OTP and identification information of the first service provider, such as the identification code the first service provider 120, in the received the second request by using said at least one server 132, so as to transmit information relevant to the corresponding account 136 to the terminal device 124 of the first service provider 120 to complete the authentication.

In one embodiment, the terminal device is an intelligent workstation or an internal computer system of the first service provider.

In one embodiment, the plurality of service providers comprise financial institutions.

In one embodiment, the plurality of service providers comprise insurance companies.

In one embodiment, the plurality of service providers comprise banks.

In one embodiment, the at least one server comprises at least one server of a depository and clearing house and the plurality of service providers are associated with the depository and clearing house.

In one embodiment, the Universal OTP is a one-dimensional bar code or a two-dimensional barcode, wherein the Universal OTP is displayed on the screen of the user's mobile device, and the counter clerk of the first service provider scans the Universal OTP using the scanning device to input into the terminal device so as to transmit the second request.

In one embodiment, the user inputs a password corresponding to the first account before the first request is transmitted via the mobile device of the user, said at least one server compares the first account, the at least one server compares the first account number, the pass password, and the mobile phone number or the mobile phone number of the mobile device to verify the user's identity.

In one embodiment, the Universal OTP is a one-dimensional bar code or a two-dimensional barcode, wherein the Universal OTP is displayed on the screen of the user's mobile device, and the counter clerk of the first service provider scans the Universal OTP using the scanning device to input into the terminal device so as to transmit the second request.

FIG. 2 is a flow chart illustrating a method of using a Universal one-time password (OTP) to authenticate a user with a plurality of service providers. In a step 211, at least one server 132 receives a first request from a first account 134 on a mobile device 110 of a user 112, wherein the first account 134 is associated with said at least one server 132, wherein the first account 134 is associated with a plurality of second accounts 138 corresponding to a plurality of service providers 128, wherein information of the plurality of second accounts 138 are associated with said at least one server 132. In a step 212, said at least one server 132 transmits a Universal OTP to the mobile device 110 of the user 112, wherein the Universal OTP is not bound to any particular one of the plurality of second accounts 138. In a step 213, the at least one server 132 receives a second request from a terminal device 124 of a first service provider 120, wherein the second request comprises said Universal OTP and identification information of the first service provider 120, such as the identification code of brokerage firm or bank. In a step 214, a corresponding account 136 of the plurality of second accounts of the first service provider is determined according to the Universal OTP and identification information of the first service provider, such as the identification code the first service provider 120, by using said at least one server 132, so as to transmit information relevant to the corresponding account 136 to the terminal device 124 of the first service provider 120 to complete the authentication.

The aforementioned service provider may be a financial institution such as a brokerage firm, wherein the at least one server 132 may be managed by system architecture of an unbiased third party 130, wherein the unbiased third party may be a body that manages securities transactions, such as a depository and clearing house, wherein the first account 134 is registered in an institution that manages securities transactions, such as a depository and clearing house whereas the second account is an account registered at a brokerage firm by the user 112. The institution that manages the securities transaction data, e.g. a depository and clearing house, owns the at least one server 132 and the at least one server 132 has all transaction data of the second account. In one embodiment, the user 112 may have multiple security accounts, wherein the institution that manages the securities transaction data, e.g. a depository and clearing house, owns the at least one server 132 having all transaction data of the security accounts of the user.

The aforementioned service provider may be a bank, wherein at least one server 132 may be a third party, such as an institution that manages the transaction data between the user and the bank. For example, the first account 134 is registered at an institution managing the transaction data of bank accounts, and the second account is the account registered by the user 112 at a bank. In one embodiment, the user 112 may have multiple bank accounts, wherein the institution that manages the transaction data of bank accounts owns the at least one server 132 that is associated with all the bank transaction data of the accounts of the user.

In one embodiment, the user 112 has a mobile device 110, and the mobile device 110 has an application 118. In one embodiment, the application 118 is provided to the user 112 by an institution that manages the security transaction data, such as a depository and clearing house. The application 118 may communicate with the at least one server 132 to inquire about all of the transaction data of accounts of the user 112. An interface of the application 118 may communicate with the at least one server 132 to obtain a Universal One Time Password (Universal OTP) from the at least one server 132. The Universal OTP can be displayed on the interface of the application 118 so that the counter clerk of the brokerage firm can input the Universal OTP. The Universal OTP can be manually inputted by inputting a series of code in digit/text format or scanning a one-dimensional bar code or a two-dimensional bar code, such as a QR code. After the counter clerk of the brokerage firm inputs the Universal OTP into the terminal device 124, the terminal device 124 will transmit the Universal OTP and the identification information of the first service provider 120, e.g. the identification code of the brokerage firm, to the at least one server 132. The at least one server 132 determines whether or not the user 112 owns a brokerage account of the brokerage firm based on the Universal OTP and the identification information of the first service provider 120. If the user 112 indeed owns the brokerage account, the at least one server 132 completes the authentication procedure of the user 112 and transmits the brokerage account information to the terminal device 124 to enable the counter clerk to provide follow-up services to the user. If the user 112 does not own an account of the brokerage firm, the at least one server 132 transmits an authentication failure message to the terminal device 124. The counter clerk of the brokerage firm is prompted to indicate to the user 112 whether or not the user 112 wishes to open an account with the brokerage firm to proceed with subsequent account opening.

In one embodiment, the mobile device 110 of the user 112 is the only device that can be used to communicate with the at least one server 132 to inquire on all transaction data of the brokerage accounts of the user 112 or to acquire the Universal OTP for obtaining a service.

In one embodiment, a mobile phone number or an identification of the mobile device 110 of the user 112 will be stored in the at least one server 132 so that the mobile device 110 can be used to communicate with the at least one servo 132 to inquire on all of the transaction data of the user 112 or to acquire the Universal OTP for obtaining a service. This ensures that no other mobile phones can be used to inquire on the transaction data of the brokerage accounts of the user 112 or acquire a one-time password for obtaining a service.

In one embodiment, the mobile device 110 may be a mobile phone, but also may be a tablet computer, but not limited thereto.

In one embodiment, the Universal OTP may be an identification code of a number, a character, a symbol, or a combination thereof, a one-dimensional bar code or a two-dimensional bar code, such as QR code, but not limited thereto.

In one embodiment, the Universal OTP has a valid period, e.g. 15 minutes or 30 minutes, but not limited thereto. If the user 112 acquires a Universal OTP and does not have the counter clerk of the brokerage firm input the Universal OTP, the acquired Universal OTP will be invalidated. The user 112 will have to acquire a new Universal OTP to complete the authentication procedure.

In one embodiment, the application 118 of the mobile device 110, e.g. a mobile securities passbook application running on the mobile device 110, may communicate with the at least one server 132 to inquire on electronic securities passbooks of multiple bank accounts of the user 112; that is, electronic securities passbooks can replace the traditional bank securities passbooks. The authentication procedure of the aforementioned Universal OTP will replace the magnetic barcode on the traditional securities passbook such that the user 112 can inquire on electronic securities passbooks of the multiple brokerage accounts simply by using the application 118 of the mobile device 110. The user 112 may also use the application 118 of the mobile device 110 to acquire the Universal OTP so as to work with the counter clerk of the bank to complete the authentication procedure together. The counter clerk of the brokerage firm is enabled to provide follow-up services to the user. If the user 112 does not own the account of the brokerage firm, the at least one server 132 transmits an authentication failure message to the terminal device 124. In this way, the user simply uses the application 118 of the mobile device 110 to achieve the functions of multiple traditional bank paper passbooks, making it unnecessary for the user to manage the multiple traditional bank paper passbooks.

In one embodiment, the user 112 registers the first account 134 in the at least one server 132 of an institution that manages security transaction data at the counter of a brokerage firm, e.g. a depository and clearing house, using the application 118 of the mobile device 110.

In one embodiment, the user 112 registers the second account in the at least one server 132 of an institution that manages securities transaction data at the counter of a brokerage firm, e.g. a depository and clearing house, using the application 118 of the mobile device 110.

In one embodiment, the user 112 may first register the first account 134 in the at least one server 132 of an institution that manages security transaction data, e.g. a depository and clearing institution, using (APP) using the application 118 of the mobile device 110. The user then registers the second account of a brokerage firm in the at least one server 132 using the application 118 of the mobile device 110.

In one embodiment, the user 112 can communicate with the at least one server 132 to download the electronic security passbooks of the multiple brokerage firms of the user 112 for the user 112 to browse simply by using the application 118 of the mobile device 110, e.g. a mobile securities passbook application. In one embodiment, the downloaded electronic security passbooks of the multiple brokerage accounts may be stored in a storage device of the mobile device 110 for the user 112 to browse the downloaded electronic security passbooks of the multiple brokerage accounts when the mobile device 110 of the user 112 is not connected to the at least one server 132. In one embodiment, the application 118 of the mobile device 110, e.g. a mobile securities passbook application, can be manipulated to browse the downloaded electronic security passbooks of the multiple brokerage accounts in the same way as on-line browsing the electronic security passbooks of the multiple brokerage accounts when the mobile device 110 of the user 112 is connected to the at least one server 132. That is, the application 118 of the mobile device 110, e.g. a mobile securities passbook application, is capable of using the same interface and operations to browse the electronic security passbooks of the multiple brokerage accounts of the user 112 regardless of whether the mobile device 110 is connected to the at least one server 132 or not. In such a manner, the user 112 is allowed to use the mobile device to browse his multiple electronic security passbooks in a transparent way.

In one embodiment, the application 118 of the mobile device 110, such as a mobile securities passbook application, can communicate with the at least one server 132, the at least one server 132 pack the data of electronic security passbook and returns the packaged electronic security passbook back to the user 112 using a registered e-mail of the user.

In one embodiment, the user 112 may receive the latest news or official up-to-date message about the security through the application 118 of the mobile device 110.

In one embodiment, the application 118 of the mobile device 110, e.g. a mobile banking passbook application, may communicate with the at least one server 132 to check electronic bank passbooks of multiple bank accounts of the user 112; that is, electronic bank passbooks can replace the traditional bank paper passbooks. The authentication procedure of the aforementioned Universal OTP will replace the magnetic barcode on the traditional paper passbook such that the user 112 can check electronic bank passbooks of the multiple bank accounts simply by using the application 118 of the mobile device 110. The user 112 may also use the application 118 of the mobile device 110 to acquire the Universal OTP so as to work with the counter clerk of the bank to the authentication the user 112. The counter clerk of the bank can then provide a service to the user. If the user 112 does not own the account of the bank, the at least one server 132 transmits an authentication failure message to the terminal device 124. The counter clerk of the brokerage firm is prompted to indicate to the user 112 whether or not the user 112 wishes to open an account with the brokerage firm to proceed with subsequent account opening. In this way, the user simply uses the application 118 of the mobile device 110, e.g. a mobile banking passbook application to achieve the functions of multiple traditional bank paper passbooks, making it unnecessary for the user to manage the multiple traditional bank paper passbooks.

In one embodiment, the application 118 of the mobile device 110 may be manipulated to browse the downloaded electronic bank passbooks of the multiple bank accounts, and the application 118 may use the same interface and operations to browse the downloaded electronic bank passbooks of multiple bank accounts. That is, the application 118 of the mobile device 110 may use the same interface and operations to browse the electronic bank passbooks of the multiple bank accounts of the user 112 regardless of whether or not the mobile device 110 is connected to the at least one server 132. In such a manner, the user 112 is allowed to use the mobile device to browse his multiple electronic bank passbooks more conveniently.

In one embodiment, the at least one server may connect to terminal devices of multiple banks. Each user may establish an account at any of the banks. The at least one server may obtain all bank account information of the user and provides a mobile device application to enable the user to communicate with the at least one server to check the status of all of the electronic passbooks. The mobile APP provides an integrated interface that links to all of the user's bank accounts so that the users can browse all of his bank accounts by using the mobile APP. When a user has multiple bank accounts, the mobile APP may provide an integrated interface for the user to acquire a Universal OTP and then hand it to any of the multiple banks. When a terminal device of a certain bank scans or inputs the Universal OTP acquired by the user, the terminal device sends a request to the at least one server, wherein said request comprises the identification code of the bank. The at least one server then verifies that the user truly owns the bank account based on the identification code of the bank contained in the request and the Universal OTP, and then transmits the brokerage account information of the user to the terminal device of the bank to complete the authentication procedure. That is, when a user acquires the Universal OTP, the Universal OTP is not bound to any bank. Until a bank scans or inputs the Universal OTP, the Universal OTP is bound to this bank. The user can therefore have a number of different bank accounts. However, the user interface to acquire the Universal OTP is not mandatory to list all the bank accounts of the user for the user to choose.

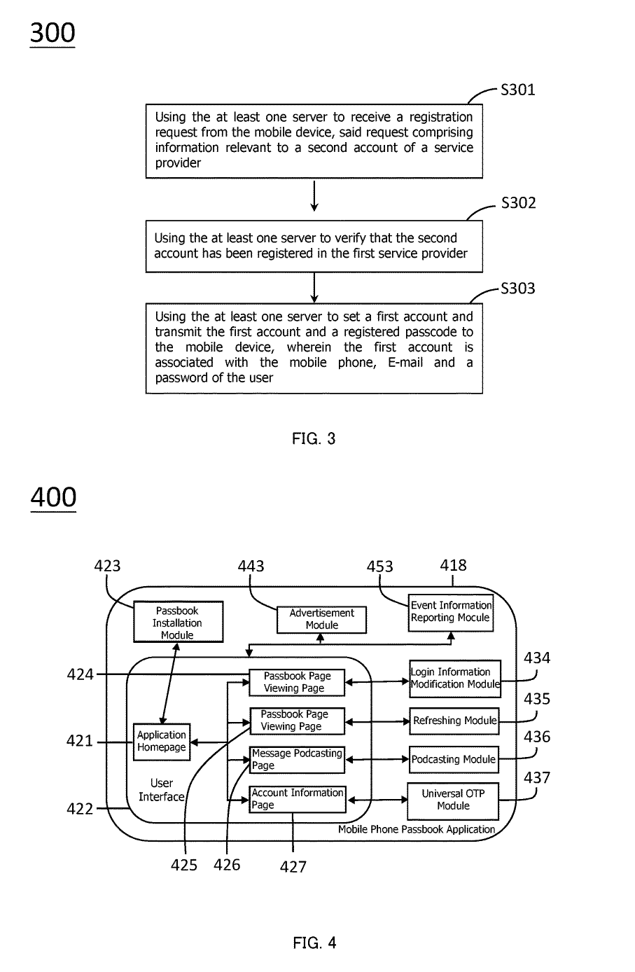

FIG. 3 a flow chart illustrating registration of the first account 134 for obtaining a one-time password. In a step 301, the at least one server 132 receives a registration request from the mobile device 110, said request comprising information relevant to a second account 136 of a service provider 120. In a step 302, the at least one server 132 verifies that the second account 136 has been registered in the first service provider 120 and recorded in the at least one server 132. In a step 303, the at least one server 132 sets a first account 134 and transmits the first account 134 and a registered passcode to the mobile device 110, wherein the first account 134 is associated with the mobile phone, E-mail and a password of the user 112. In one embodiment, the user 112 does not have to have the second account 136 when the user 112 registers the first account 134; that is, the user 112 may first register the first account 134 and then proceed to any brokerage firm to register one of the brokerage accounts.

FIG. 4 is a structural diagram of a mobile phone passbook application. As shown in FIG. 4, the mobile phone passbook application 418 architecture is divided into a user interface 422 and a corresponding function module. The user interface 422 comprises an account management page 424, a passbook page viewing page 425, a message podcasting page 426, and an account information page 427. Features of the mobile phone passbook application 418 comprise passbook installation, graphic advertising, user activity, investor login information modification, historical passbook record display, online refreshing, podcasting function and Universal OTP acquisition and display.

To enhance interactivity and the need for personalized service, the mobile phone passbook application 418 can provide investors with another version of security passbook. After the application has been approved, the mobile passbook account can be installed on the investor's mobile carrier, then the passbook refreshing and related operations can be implemented. As for the mobile phone passbook application 418, the traditional passbook magnetic strip can be replaced with the Universal OTP, to reconfirm the passbook transfer operation for over-the-counter service, and to provide the investor active, instant and mobilized transaction data and balance registering. The mobile passbook will not only have securities passbook function, integrating into mobile devices in digital way to implement electronic and mobilized services, but also strengthen connection with investors. The mobile phone passbook application 418 can provide value-added services, including shares relevant information and related promotion information. On the other hand, the mobile phone passbook application 418 can provide the podcasting function of the depository and clearing house, such as informing investors to refresh passbook, shareholder meeting and other investors' business related information.

In one embodiment, the mobile phone passbook application 418 may be used to inquire on data of the electronic securities passbooks of all brokerage firms of the user as well as to acquire a Universal OTP to complete the authentication procedure. The counter clerk of the brokerage firm is enabled to provide follow-up services to the user 112. In one embodiment, the mobile phone passbook application 418 may be used to generate as well as use the Universal OTP to complete the authentication procedure.

In one embodiment, the mobile phone passbook application 418 can be used in mobile passbook refreshing and review operations. During the passbook refreshing between the depository and clearing house and the depositor, the identification is based on “collective depository account +mobile device identification code”, as following: the user clicks on the desired passbook to be refreshed through the mobile phone passbook application 418, then the depository and clearing house checks that the account information is accurate, and transfers the un-refreshed data of the account to the user's mobile phone, and sets the un-refreshed data to be refreshed. The user may sort the data according to the transaction date, the securities code, the type of transaction (ordinary/credit), and view the data according to the transaction date and the sequence of the securities codes.

In one embodiment, it concerns the depositor passbook transfer operation for over-the-counter service. The user clicks on the function of producing general one-time password through the mobile phone passbook application 418, and enters the password. The server in the depository and clearing house verifies that the account related information is accurate, and produces and transfers the Universal OTP to the user's mobile phone, and sets the Universal OTP to be “application” and the valid time for 30 minutes. Various accounting transactions are prompted as mobile passbook for users, which should be checked whether the Universal OTP is valid and accurate for using, and then the Universal OTP is set to be “used”.

In one embodiment, as for mobile passbook balance registering, the depositor clicks on the function of passbook balance registering through the mobile phone passbook application 418. The server in the depository and clearing house checks that the account related information is accurate, then transfers the account balance registering information (general balance and credit balance) to the user's mobile phone.

In one embodiment, the mobile phone passbook application 418 may display a graphic advertisement, such as a graphic advertisement of a brokerage firm.

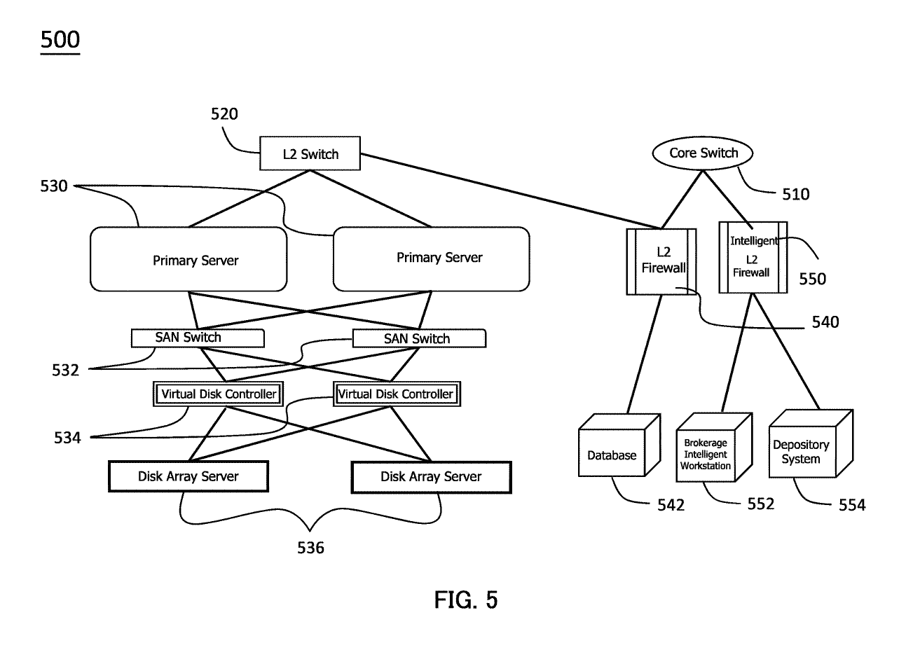

FIG. 5 is a schematic view of the hardware architecture of the system of an unbiased third party in FIG. 1, e.g. a depository and clearing house. As shown in FIG. 5, the hardware architecture of the depository system is divided into a second layer switch (L2 Switch) 520 and a core switch 510. The second layer switch (L2 Switch) 520 is connected to the primary server 530 and the second layer firewall (L2 Firewall) 540 of the network. The storage area network switch (SAN switch) 532 is connected to the disk array server 536 through the virtual disk controller 534. The core switch 510 and the second layer switch (L2 Switch) 520 are connected to the database 542 through the second layer firewall (L2 Firewall) 540 of the network. The core switch 510 is connected to the brokerage intelligent workstation 552 and the depository system 554 through the intelligent second layer firewall (Intelligent L2 Firewall) 550. The hardware architecture of the depository system 554 employs the virtual machine architecture. The primary server 530 can open the electronic bookkeeping services, the SMS services, the e-mail services, the message queue services, the Universal OPT service, the podcasting service, the advertising content services, etc., respectively and bridge the internal and external demanding network segment with the virtual disk controller 534. The hardware architecture of the depository system 554 builds the service on two separate primary servers 530 and operates with the virtual disk controller 534, respectively. The data storage space of the depository system 554 can use the disk array server 536 to carry out data storage operations. External disk array server 536 can deploy two machines of the same type with high availability.

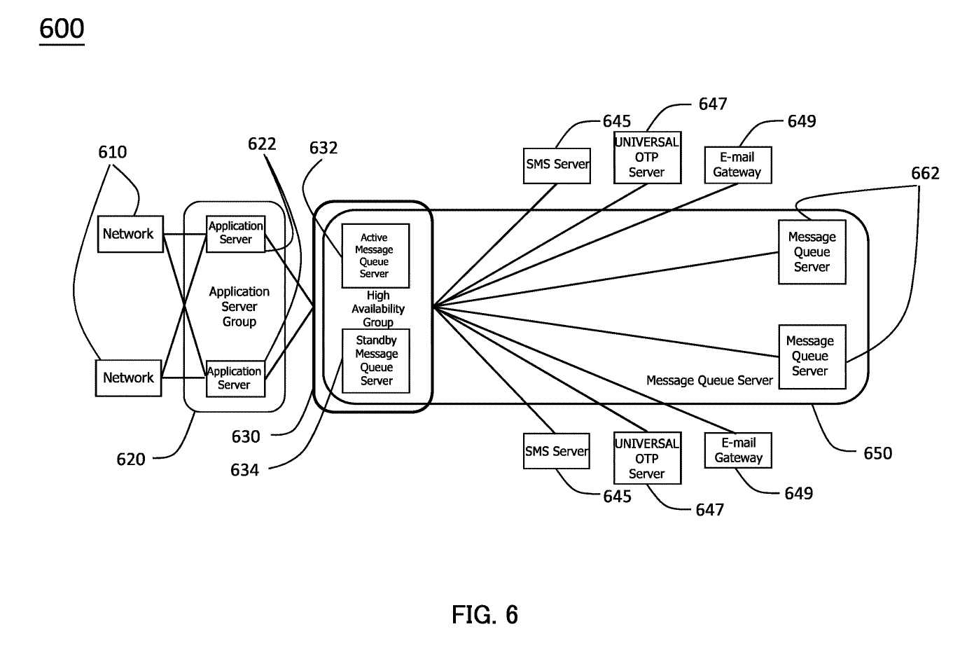

FIG. 6 is a schematic view of the software architecture of the depository system 554. As shown in FIG. 6, the application server group 620 includes an application server 622, a depository system 554 software architecture that uses a Linux high availability group 630 so as to keep the depository system 554 working normally at all times. The Linux high availability group 630 comprises an Active Message Queue Server 632 and a Standby Message Queue Server 634. A Message Queue group 650 comprises the Linux high availability group 630 and a Message Queue Server 662. The user 112 may be connected to the application server 622 via the network 610. The application server 622 is connected to the SMS server 645, the Universal OTP server 647, the e-mail gateway 649, and the Message Queue Server 662 through the Linux High Availability group 630.

The server of the depository and clearing house is connected to terminal devices of multiple brokerage firms. Each user may establish an account at any of the brokerage firms. The server of the depository and clearing house may obtain all brokerage account information of the user and provides a mobile device application to enable the user to communicate with the at least one server to know the status of all of the electronic passbooks. The mobile APP provides an integrated interface that links to all of the user's brokerage accounts so that the users can browse all of his brokerage accounts by using the mobile APP. When a user has multiple brokerage accounts, the mobile APP may provide an integrated interface for the user to acquire a Universal OTP and then hand it to any of the multiple brokerage firms. When a terminal device of a certain brokerage firm scans or inputs the Universal OTP acquired by the user, the terminal device sends a request to the at least one server, wherein said request comprises the identification code of the brokerage. The at least one server then verifies that the user truly owns the brokerage firm account based on the identification code of the brokerage firm contained in the request and the Universal OTP, and then transmits the brokerage account information of the user to the terminal device of the brokerage firm to complete the authentication procedure. That is, when a user acquires the Universal OTP, the Universal OTP is not bound to any brokerage firm, until a brokerage firm scans or inputs the Universal OTP, the Universal OTP is bound to this brokerage firm. The user can therefore have a number of different brokerage accounts. Please note that the user interface to acquire the Universal OTP is not mandatory to list all the brokerage accounts of the user for the user to choose.

The software architecture of the depository system 554 can allows the system to use multiple servers instead of single server by taking advantage of the high availability and load balancing features of the software architecture. Through this mechanism, the traffic load can be distributed equally to each server to achieve load balancing. If the server is shut down in the group, a load balancing manager can direct the connection to other servers, thereby providing uninterrupted network services. The load balancing architecture provides the following benefits: increased reliability, improved server service performance, easier server management, independence of hardware platform or operating systems, and no interruption due to a switch failure.

While the present invention has been described above with reference to the aforementioned preferred embodiments, it is not intended to limit the present invention. One person skilled in the art will appreciate a few alterations and modifications without departing from the spirit and scope of the invention. The scope of protection of the present invention is subject to the scope of the patent application as set forth in this specification.

What is claimed is:

1. A method for authenticating a user with service providers using a Universal OTP, comprising the steps:
receiving a first request from a first account on a mobile device of a user using at least one server, wherein the first account is associated with said at least one server, wherein the first account is associated with a plurality of second accounts corresponding to a plurality of service providers, wherein information of the plurality of second accounts are associated with said at least one server;
transmitting a Universal OTP to the mobile device of the user using said at least one server, wherein the Universal OTP is not bound to any particular one of the plurality of second accounts;
receiving a second request from a terminal device of a first service provider using said at least one server, wherein the second request comprises said Universal OTP and identification information of the first service provider; and
determining a corresponding account of the plurality of second accounts of the first service provider according to the Universal OTP and identification information of the first service provider using said at least one server so as to transmit information relevant to the corresponding account to the terminal device of the first service provider to complete the authentication.

2. The method of claim 1, wherein the terminal device is an intelligent workstation or an internal computer system of the first service provider.

3. The method of claim 1, wherein the plurality of service providers comprises financial institutions.

4. The method of claim 1, wherein the plurality of service providers comprises brokerage firms.

5. The method of claim 1, wherein the plurality of service providers comprises banks.

6. The method of claim 1, wherein said at least one server comprises at least one server of a depository and clearing house and the plurality of service providers are associated with the depository and clearing house.

7. The method of claim 1, wherein the user inputs a password corresponding to the first account before the first request is transmitted via the mobile device of the user, the at least one server compares the first account number and the pass password to verify the identity of the user.

8. The method of claim 1, wherein the Universal OTP is a bar code or a two-dimensional barcode, wherein the Universal OTP is displayed on the screen of the user's mobile device, and the counter clerk of the first service provider scans the Universal OTP to input the Universal OTP to the terminal device so as to transmit the second request.

9. A system for authenticating a user with a plurality of service providers using a Universal OTP, comprising:
at least one server for receiving a first request from a first account on a mobile device of a user, wherein the first account is associated with said at least one server, wherein the first account is associated with a plurality of second accounts corresponding to a plurality of service providers, wherein information of the plurality of second accounts are associated with said at least one server and a Universal OTP is transmitted to the mobile device of the user, wherein the Universal OTP is not bound to any particular one of the plurality of second accounts; and
a terminal device for inputting the Universal OTP in the mobile device and transmitting a second request to the at least one server, wherein the second request comprises said Universal OTP and identification information of the first service provider, wherein a corresponding account of the plurality of second accounts of the first service provider according to the Universal OTP and identification information of the first service provider is determined by using the at least one server so as to transmit information relevant to the corresponding account to the terminal device of the first service provider to complete the authentication.

10. The system of claim 9, wherein the plurality of service providers comprises brokerage firms.

11. The system of claim 9, wherein the plurality of service providers comprises banks.

12. The system of claim 10, wherein the at least one server comprises at least one server of a depository and clearing house and the plurality of service providers are associated with the depository and clearing house.

13. The system of claim 9, wherein the Universal OTP is a bar code or a two-dimensional barcode, wherein the Universal OTP is displayed on the screen of the user's mobile device, and the counter clerk of the first service provider scans the Universal OTP using the scanning device to input to the terminal device so as to transmit the second request.

14. The system of claim 9, wherein the user inputs a password corresponding to the first account before the first request is transmitted via the mobile device of the user, said at least one server compares the first account, the at least one server compares the first account number, the pass password, and the mobile phone number or the mobile phone number of the mobile device to verify the user's identity.

15. The system of claim 9, wherein the Universal OTP is a bar code or a two-dimensional barcode, wherein the Universal OTP is displayed on the screen of the user's mobile device, and the counter clerk of the first service provider scans the Universal OTP using the scanning device to input to the terminal device so as to transmit the second request.

16. The system of claim 9, wherein the terminal device is an intelligent workstation or an internal computer system of the first service provider.
